(19) United States
(12) Patent Application Publication
(10) Pub. No.: US 2024/0305353 A1
(43) Pub. Date: Sep. 12, 2024

(54) BEAM FAILURE DETECTION FOR A PHYSICAL DOWNLINK CONTROL CHANNEL MONITORING OPERATION CORRESPONDING TO AT LEAST TWO TRANSMISSION CONFIGURATION INDICATOR STATES

(71) Applicant: QUALCOMM Incorporated, San Diego, CA (US)

(72) Inventors: Fang YUAN, Beijing (CN); Muhammad Sayed Khairy ABDELGHAFFAR, San Jose, CA (US); Yan ZHOU, San Diego, CA (US); Tao LUO, San Diego, CA (US)

(21) Appl. No.: 18/550,370

(22) PCT Filed: Apr. 30, 2021
(86) PCT No.: PCT/CN2021/091630

§ 371 Date: Sep. 13, 2023

(51) Int. Cl. H04B 7/06

(52) U.S. Cl. CPC H04B 7/06964; H04B 7/0626; H04B 7/06968

(57) ABSTRACT

Various aspects of the present disclosure generally relate to wireless communication. In some aspects, a user equipment (UE) may determine, based at least in part on a beam failure detection reference signal configuration, a beam failure detection reference signal resource set associated with a physical downlink control channel (PDCCH) monitoring operation corresponding to at least two transmission configuration indicator (TCI) states. The UE may monitor the beam failure detection reference signal resource set to identify a beam failure. Numerous other aspects are described.

### FIELD OF THE DISCLOSURE

Aspects of the present disclosure generally relate to wireless communication and to techniques and apparatuses for beam failure detection for a physical downlink control channel monitoring operation corresponding to at least two transmission configuration indicator states.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes a memory; and one or more processors, coupled to the memory, configured to: determine, based at least in part on a beam failure detection reference signal configuration, a beam failure detection reference signal resource set associated with a physical downlink control channel (PDCCH) monitoring operation corresponding to at least two transmission configuration indicator (TCI) states; and monitor the beam failure detection reference signal resource set to identify a beam failure.

In some aspects, a base station for wireless communication includes a memory; and one or more processors, coupled to the memory, configured to: transmit a beam failure detection reference signal based at least in part on a beam failure detection reference signal configuration, wherein the beam failure detection reference signal corresponds to a beam failure detection reference signal resource set associated with a PDCCH monitoring operation corresponding to at least two TCI states; and receive an indicator that indicates at least one new beam indication reference signal based at least in part on an identification of a beam failure.

In some aspects, a method of wireless communication performed by UE includes determining, based at least in part on a beam failure detection reference signal configuration, a beam failure detection reference signal resource set associated with a PDCCH monitoring operation corresponding to at least two TCI states; and monitoring the beam failure detection reference signal resource set to identify a beam failure.

In some aspects, a method of wireless communication performed by a base station includes transmitting a beam failure detection reference signal based at least in part on a beam failure detection reference signal configuration, wherein the beam failure detection reference signal corresponds to a beam failure detection reference signal resource set associated with a PDCCH monitoring operation corresponding to at least two TCI states; and receiving an indicator that indicates at least one new beam indication reference signal based at least in part on an identification of a beam failure.

In some aspects, a non-transitory computer-readable medium storing a set of instructions for wireless communication includes one or more instructions that, when executed by one or more processors of a UE, cause the UE to: determine, based at least in part on a beam failure detection reference signal configuration, a beam failure detection reference signal resource set associated with a monitoring operation corresponding to at least two TCI states; and monitor the beam failure detection reference signal resource set to identify a beam failure.

In some aspects, a non-transitory computer-readable medium storing a set of instructions for wireless communication includes one or more instructions that, when executed by one or more processors of a base station, cause the base station to: transmit a beam failure detection reference signal based at least in part on a beam failure detection reference signal configuration, wherein the beam failure detection reference signal corresponds to a beam failure detection reference signal resource set associated with a PDCCH monitoring operation corresponding to at least TCI states; and receive an indicator that indicates at least one new beam indication reference signal based at least in part on an identification of a beam failure.

In some aspects, an apparatus for wireless communication includes means for determining, based at least in part on a beam failure detection reference signal configuration, a beam failure detection reference signal resource set associated with a PDCCH monitoring operation corresponding to at least two TCI states; and means for monitoring the beam failure detection reference signal resource set to identify a beam failure.

In some aspects, an apparatus for wireless communication includes means for transmitting a beam failure detection reference signal based at least in part on a beam failure detection reference signal configuration, wherein the beam failure detection reference signal corresponds to a beam failure detection reference signal resource set associated with a PDCCH monitoring operation corresponding to at least two TCI states; and means for receiving an indicator that indicates at least one new beam indication reference signal based at least in part on an identification of a beam failure.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antenna, radio frequency (RF) chains, power amplifiers, modulators, buffer, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of multiple transmit receive point (multi-TRP) communications, in accordance with the present disclosure.

FIG. 4 is a diagram illustrating an example associated with beam failure detection for a physical downlink control channel (PDCCH) monitoring operation corresponding to at least two transmission configuration indicator (TCI) states, in accordance with the present disclosure.

FIGS. 5 and 6 are diagrams illustrating example processes associated with beam failure detection for a PDCCH monitoring operation corresponding to at least two TCI states, in accordance with the present disclosure.

FIGS. 7 and 8 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

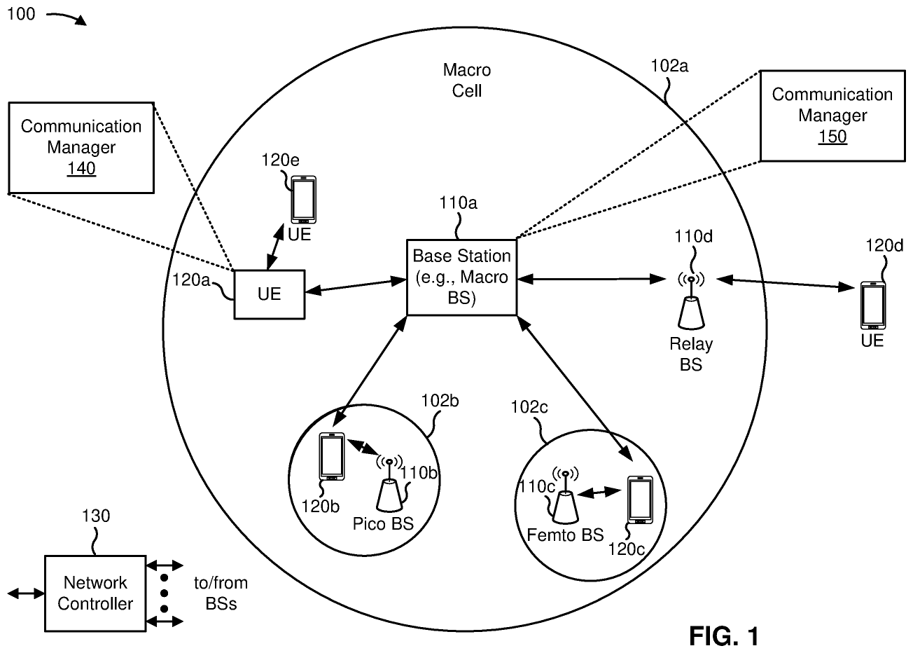

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, the UE 120 may include a communication manager 140. As described in more detail elsewhere herein, the communication manager 140 may determine, based at least in part on a beam failure detection reference signal configuration, a beam failure detection reference signal resource set associated with a physical downlink control channel (PDCCH) monitoring operation corresponding to at least two transmission configuration indicator (TCI) states; and monitor the beam failure detection reference signal resource set to identify a beam failure. Additionally, or alternatively, the communication manager 140 may perform one or more other operations described herein.

In some aspects, the base station 110 may include a communication manager 150. As described in more detail elsewhere herein, the communication manager 150 may transmit a beam failure detection reference signal based at least in part on a beam failure detection reference signal configuration, wherein the beam failure detection reference signal corresponds to a beam failure detection reference signal resource set associated with a PDCCH monitoring operation corresponding to at least two TCI states; and receive an indicator that indicates at least one new beam indication reference signal based at least in part on an identification of a beam failure. Additionally, or alternatively, the communication manager 150 may perform one or more other operations described herein.

As indicated above, FIG. 1 is provided as an example. Other examples may differ from what is described with regard to FIG. 1.

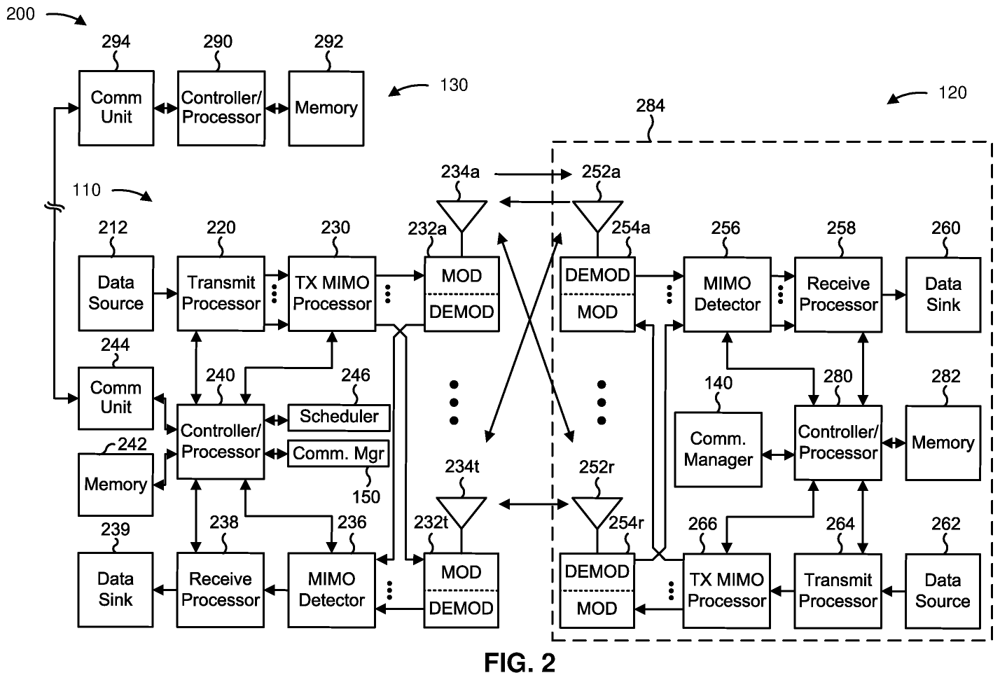

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

Each of the antenna elements may include one or more sub-elements for radiating or receiving RF signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of TCI states that respectively indicate beams that may be used by the UE, such as for receiving a physical downlink shared channel (PDSCH). The base station may indicate an activated TCI state to the UE, which the UE may use to select a beam for receiving the PDSCH.

A beam indication is an indication of a beam. A beam indication may be, or include, a TCI state information element, a beam identifier (ID), spatial relation information, a TCI state ID, a close loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a channel state information reference signal (CSI-RS) (e.g., an NZP-CSI-RS-ResourceId, an SSB-Index, and/or the like), and/or the like. Spatial relation information may similarly indicate information associated with an uplink beam.

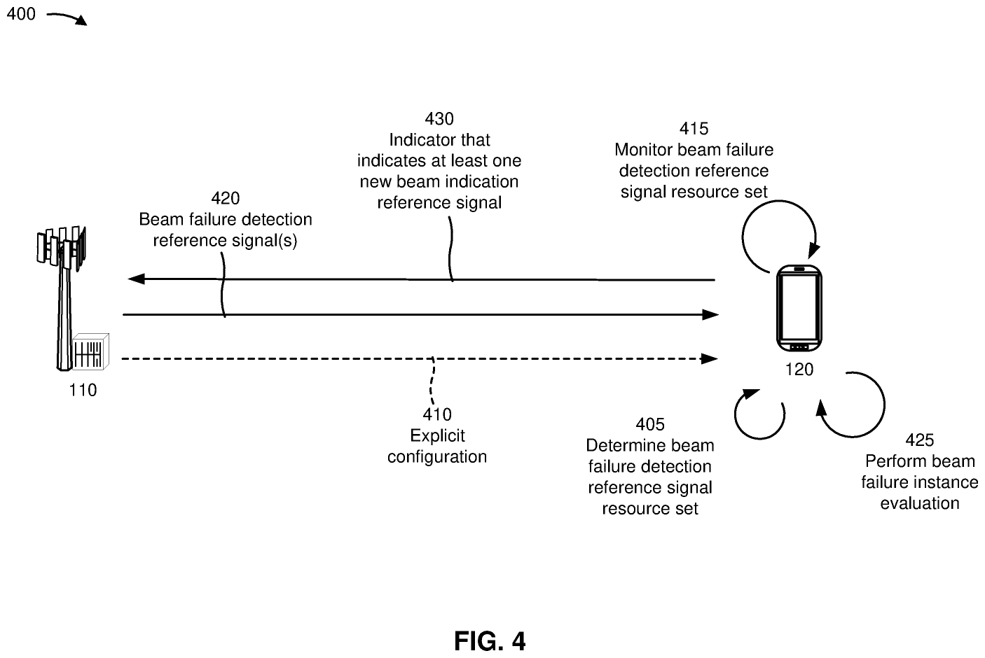

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 4-6.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 4-6.

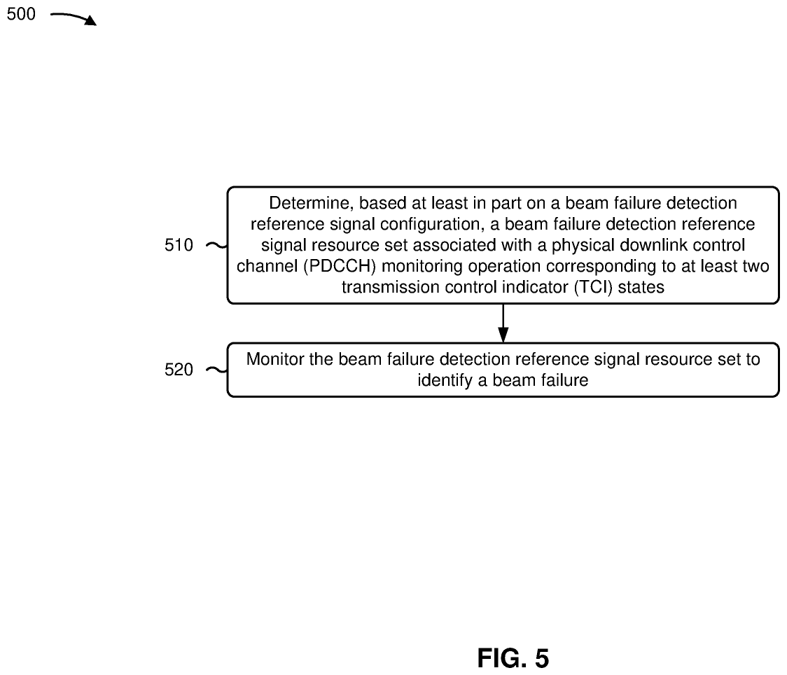

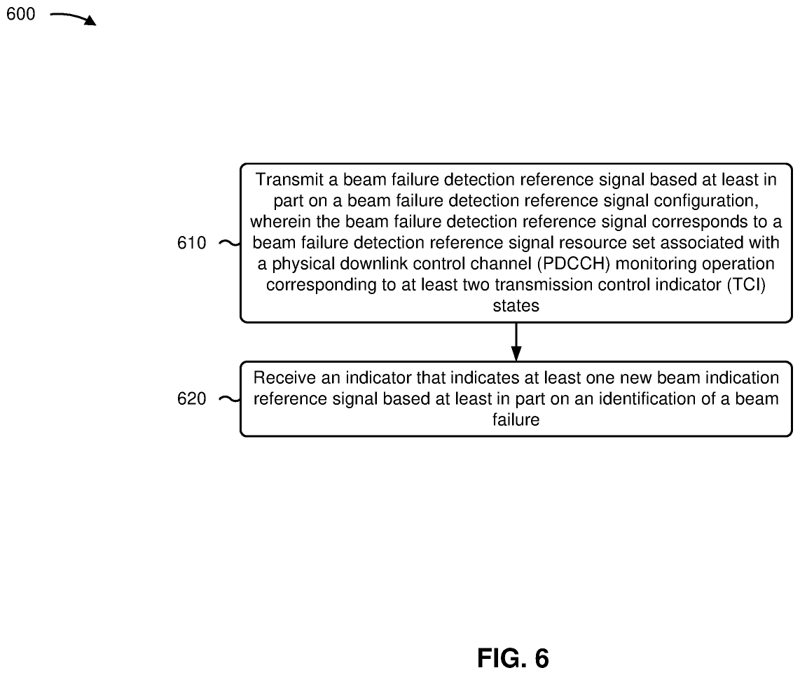

Controller/processor 240 of base station 110, controller/processor 280 of UE 120, and/or any other component(s) of FIG. 2 may perform one or more techniques associated with beam failure detection for a PDCCH monitoring operation corresponding to at least two TCI states, as described in more detail elsewhere herein. In some aspects, the TRP described herein is the base station 110, is included in the base station 110, or includes one or more components of the base station 110 shown in FIG. 2. For example, controller/processor 240 of base station 110, controller/processor 280 of UE 120, and/or any other component(s) of FIG. 2 may perform or direct operations of, for example, process 500 of FIG. 5, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some aspects, executing instructions may include running the instructions, converting the instructions, compiling the instructions, and/or interpreting the instructions, among other examples.

In some aspects, the UE includes means for determining, based at least in part on a beam failure detection reference signal configuration, a beam failure detection reference signal resource set associated with a PDCCH monitoring operation corresponding to at least two TCI states; and/or means for monitoring the beam failure detection reference signal resource set to identify a beam failure. The means for the UE to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the base station includes means for transmitting a beam failure detection reference signal based at least in part on a beam failure detection reference signal configuration, wherein the beam failure detection reference signal corresponds to a beam failure detection reference signal resource set associated with a PDCCH monitoring operation corresponding to at least two TCI states; and/or means for receiving an indicator that indicates at least one new beam indication reference signal based at least in part on an identification of a beam failure. The means for the base station to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

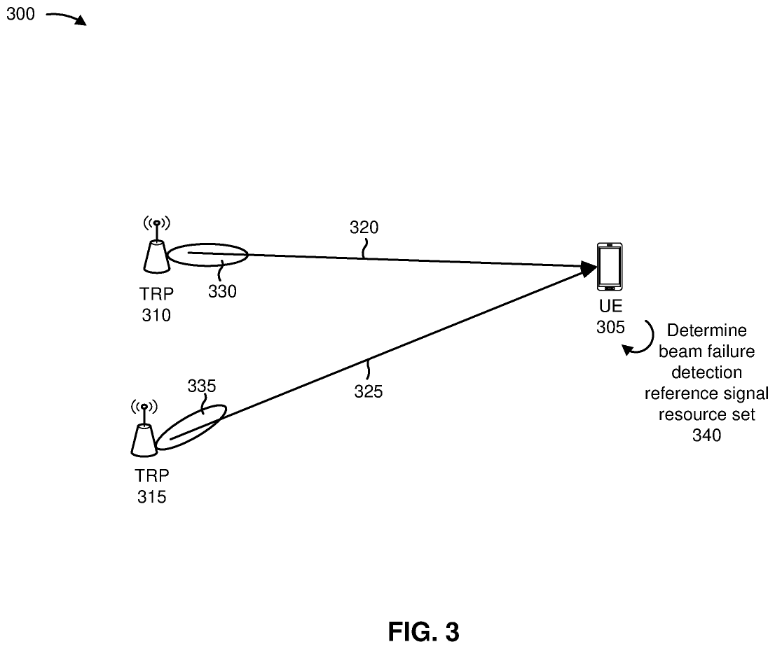

FIG. 3 is a diagram illustrating an example 300 of multi-TRP communication (sometimes referred to as multi-panel communication), in accordance with the present disclosure. As shown in FIG. 3, a UE 305 may communicate with a TRP 310 and a TRP 315. The TRPs 310 and 315 may be, include, or be included in, one or more base stations, relay devices, and/or integrated access and backhaul (IAB) nodes, among other examples.

In some cases, a multi-TRP arrangement such as is shown in FIG. 3 may be used to facilitate multiple PDCCH transmissions using two different TCI states. The TRP 310 may transmit a first PDCCH transmission 320, and the TRP 315 may simultaneously transmit an identical (or similar) second PDCCH transmission 325. The PDCCH transmissions may be transmitted using the same time and frequency resources, but different TCI states. For example, as shown, the TRP 310 may use a first beam 330 associated with a first TCI state to transmit the first PDCCH transmission 320, and the TRP 315 may use a second beam 335 associated with a second TCI state to transmit the second PDCCH transmission 325. In some cases, the multiple PDCCH transmissions 320 and 325 may be transmitted using a single frequency network (SFN). In some cases, the multiple PDCCH transmissions 320 and 325 may improve PDCCH reliability.

A corresponding control resource set (CORESET) can be configured using an RRC transmission associated with a higher layer parameter to indicate that downlink control information (DCI) and/or a PDCCH transmission received on the CORESET is associated with an SFN. In some cases, a medium access control control element (MAC-CE) activation command can be used to indicate the two TCI states. In some cases in which a single PDCCH transmission is used, beam failure detection reference signal (RS) resource sets may be indicated to a UE. The UE may use the beam failure RSs to identify the reference signals to receive and measure to determine whether a beam failure condition exists.

For example, in some cases, a UE can be provided, for each bandwidth part (BWP) of a serving cell, a set q0 of periodic CSI-RS resource configuration indexes (e.g., using a parameterfailureDetectionResources) and a set q1 of periodic CSI-RS resource configuration indexes and/or synchronization signal (SS)/physical broadcast channel (PBCH) block indexes (e.g., using a parameter candidateBeamRSList, a parameter candidateBeamRSListExt-r16, or a parameter candidateBeamRSSCellList-r16) for radio link quality measurements on the BWP of the serving cell. In some cases, if the UE is not provided q0 for a BWP of the serving cell, the UE can determine the set q0 to include periodic CSI-RS resource configuration indexes with the same values as the RS indexes in the RS sets indicated by a TCI state indication parameter (e.g., the parameter TCI-State) for respective CORESETs that the UE uses for monitoring PDCCH. If there are two RS indexes in a TCI state, the set q0 can include RS indexes with a QCL-TypeD configuration for the corresponding TCI states. In some cases, the set q0 can include up to two RS indexes. In a multi-TRP scenario with two TCI states, if a beam failure detection reference signal resource set is not indicated to the UE, the UE may not be aware of the resource set for one of the TCI states. As a result, using multi-TRP PDCCH transmission may result in undetected beam failures, which may have a negative impact on the performance of the UE and/or the network.

Some aspects of the techniques and apparatuses described herein provide for a UE determining a beam failure reference signal resource set for beam failure detection for a PDCCH monitoring operation corresponding to at least two TCI states. In some aspects, as shown by reference number 340, the UE 305 may determine a beam failure detection reference signal resource set associated with a PDCCH monitoring operation corresponding to at least two TCI states. The UE 305 may determine the beam failure detection reference signal resource set based at least in part on a beam failure detection reference signal configuration. The configuration may be an explicit configuration and/or an implicit configuration. The UE 305 may perform a beam failure instance evaluation associated with the beam failure detection reference signal resource set. In this way, some aspects may facilitate beam failure detection for a multi-TRP PDCCH transmission, thereby reducing undetected beam failures, which may have a positive impact on the performance of the UE 305 and/or the network.

As indicated above, FIG. 3 is provided as an example. Other examples may differ from what is described with respect to FIG. 3.

FIG. 4 is a diagram illustrating an example 400 of beam failure detection for a PDCCH monitoring operation corresponding to at least two TCI states, in accordance with the present disclosure. As shown in FIG. 4, a base station 110 and a UE 120 may communicate with one another. In some aspects, the base station 110 may include multiple TRPs. In some aspects, the UE 120 may communicate with one or more TRPs associated with the base station 110 and/or with another device not illustrated.

As shown by reference number 405, the UE 120 may determine a beam failure detection reference signal resource set. The UE 120 may determine the resource set based at least in part on a beam failure detection reference signal configuration. The resource set may be associated with a PDCCH monitoring operation corresponding to at least two TCI states. In some aspects, the beam failure detection reference signal configuration may include an implicit configuration and/or an explicit configuration.

For example, as shown by reference number 410, the base station 110 may transmit, and the UE 120 may receive, the explicit configuration. In some aspects, the explicit configuration may be carried in at least one of an RRC message or a MAC-CE. In some aspects, the explicit configuration may include a pairing indication that indicates at least one of a pair of CSI-RS resources or a pair of synchronization signal block (SSB) resources. In some aspects, the UE 120 may determine the beam failure detection reference signal resource set based at least in part on the pairing indication. In some aspects, the explicit configuration may include an index set indication that indicates at least one of a set of periodic CSI-RS configuration indexes or a set of SSB configuration indexes. The UE 120 may determine the beam failure detection reference signal resource based at least in part on the index set indication.

As indicated above, the beam failure detection reference signal configuration may include an implicit configuration. For example, the UE 120 may determine the beam failure detection reference signal resource set based at least in part on at least one quasi co-located (QCL) reference signal of at least one CORESET, where each CORESET of the at least one CORESET includes only a single active TCI state. The QCL reference signal of a CORESET may be the reference signal providing QCL assumptions in the TCI state of the CORESET if the reference signal in the TCI state is periodical. The QCL reference signal may be a periodical reference signal QCLed or associated with a reference signal providing QCL assumptions in the TCI state of the CORESET if the reference signal in the TCI state is not periodical. The UE 120 may determine the beam failure detection reference signal resource set to include the quasi QCL reference signals of at least one CORESET configured to the UE 120, where each CORESET of the at least one CORESET includes only a single active TCI state. When there are two reference signals providing QCL assumptions in a TCI state, the one providing QCL-type D assumption may be used. In some aspects, the UE 120 may determine the beam failure detection reference signal resource set based at least in part on at least one QCL reference signal of at least one CORESET, where each CORESET of the at least one CORESET includes either a single active TCI state or two active TCI states. The UE 120 may determine the beam failure detection reference signal resource set to include the quasi QCL reference signals of at least one CORESET configured to the UE 120, where each CORESET of the at least one CORESET includes a single active TCI state or two active TCI states. In some aspects, each CORESET of the at least one CORESET may include only two active TCI states. The UE 120 may determine the beam failure detection reference signal resource set to include the QCL reference signals of at least one CORESET configured to the UE 120, where each CORESET of the at least one CORESET includes two active TCI states.

As shown by reference number 415, the UE 120 may monitor the beam failure detection reference signal resource set to identify a beam failure. In some aspects, the UE 120 may perform the PDCCH monitoring operation by monitoring a PDCCH transmission using the at least two TCI states. In some aspects, the PDCCH transmission may include a single frequency network transmission, where the PDCCH is monitored in a CORESET and the CORESET includes two active TCI states. In some aspects, the UE 120 may perform the PDCCH monitoring operation by monitoring a PDCCH transmission corresponding to one search space set associated with two different CORESETs. In some aspects, each CORESET of the two different CORESETs may include an active TCI state.

As shown by reference number 420, the base station 110 may transmit, and the UE 120 may receive, a beam failure detection reference signal or signals. The base station 110 may transmit the reference signals based at least in part on the beam failure detection reference signal configuration. As shown by reference number 425, the UE 120 may perform a beam failure instance evaluation associated with the beam failure detection reference signal resource set. In some aspects, performing the beam failure instance evaluation may include determining at least one hypothetical block error rate calculation associated with the PDCCH transmission.

In some aspects, the beam failure detection reference signal resource set may include at least one QCL reference signal of at least one CORESET, and determining the at least one hypothetical block error rate calculation may include determining two hypothetical block error rates for each reference signal of the at least one quasi co-located reference signal. In some aspects, the beam failure detection reference signal resource set may include at least one of a pair of CSI-RS resources or a pair of SSB resources, and determining the at least one hypothetical block error rate calculation may include determining two hypothetical block error rates for each pair of the at least one of the pair of CSI-RS resources or the pair of SSB resources.

In some aspects, the at least two TCI states may correspond to at least one pair of beam failure detection reference signals and may include a first TCI state associated with an SFN and a second TCI state associated with the SFN. The first TCI state may correspond to a first beam failure detection reference signal of a pair of beam failure detection reference signals of the at least one pair of beam failure detection reference signals, and the second TCI state may correspond to a second beam failure detection reference signal of the pair of beam failure detection reference signals. The UE 120 may determine the at least one hypothetical block error rate calculation by determining one hypothetical block error rate calculation for the pair of beam failure detection reference signals.

In some aspects, determining the one hypothetical block error rate calculation for the pair of beam failure detection reference signals may include determining an average block error rate. The UE 120 may determine the average block error rate by determining a weighted average of a first hypothetical block error rate corresponding to the first beam failure detection reference signal of the pair of beam failure detection reference signals and a second hypothetical block error rate corresponding to the second beam failure detection reference signal of the pair of beam failure detection reference signals.

In some aspects, the UE 120 may determine the weighted average by determining a weighted power mean of the first hypothetical block error rate and the second hypothetical block error rate. In some aspects, determining the weighted power mean may include determining a sum of a weighted first hypothetical block error rate and a weighted second hypothetical block error rate, and determining an exponential value of the sum based at least in part on an exponent comprising a fraction in which a denominator comprises a value corresponding to a power parameter. The UE 120 may determine the weighted first hypothetical block error rate by determining a product of the first hypothetical block error rate and a first weight value and may determine the weighted second hypothetical block error rate by determining a product of the second hypothetical block error rate and a second weight value. In some aspects, a sum of the first weight value and the second weight value is equal to one.

For example, the weighted power mean may be expressed as (w₁BLER₁^{p}+w₂BLER₂^{p})^{1/p} where w₁+w₂=1 and p={−∞, . . . , −1, 0, 1 . . . ∞}. Based on the value of p, the weighted power mean may take the form of different types of means. For example, in some aspects, the weighted power mean may include a minimum of the first hypothetical block error rate and the second hypothetical block error rate (e.g., when the value of p approaches negative infinity). In some aspects, the weighted power mean may include a harmonic mean (e.g., when the value of p is −1), a geometric mean (e.g., when the value of p is 0), an arithmetic mean (e.g., when the value of p is 1), and/or a maximum of the first hypothetical block error rate and the second hypothetical block error rate (e.g., when the value of p approaches positive infinity), among other examples.

In some aspects, the UE 120 may determine, based on the evaluation, a beam failure. In some aspects, the UE 120 may determine, during a beam failure recovery procedure, at least one new beam indication reference signal based at least in part on identifying the beam failure. In some aspects, the UE 120 may determine the at least one new beam indication reference signal by determining one reference signal during the beam failure recovery procedure. In some aspects, the UE 120 may determine the at least one new beam indication reference signal by determining a first reference signal from a first new beam indication resource set and determining a second reference signal from a second new beam indication resource set.

In some aspects, determining the at least one new beam indication reference signal may include determining a first reference signal from a first new beam indication resource pair and determining a second reference signal from a second new beam indication resource pair. In some aspects, determining the at least one new beam indication reference signal may include determining a reference signal pair of a plurality of reference signal pairs. In some aspects, the beam failure recovery procedure may correspond to at least one of a primary cell, a secondary cell, or a multi-TRP operation in a cell.

As shown by reference number 430, the UE 120 may transmit, and the base station 110 may receive, an indicator that indicates the at least one new beam indication reference signal based at least in part on an identification of a beam failure.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 120) performs operations associated with beam failure detection for a PDCCH monitoring operation corresponding to at least two TCI states.

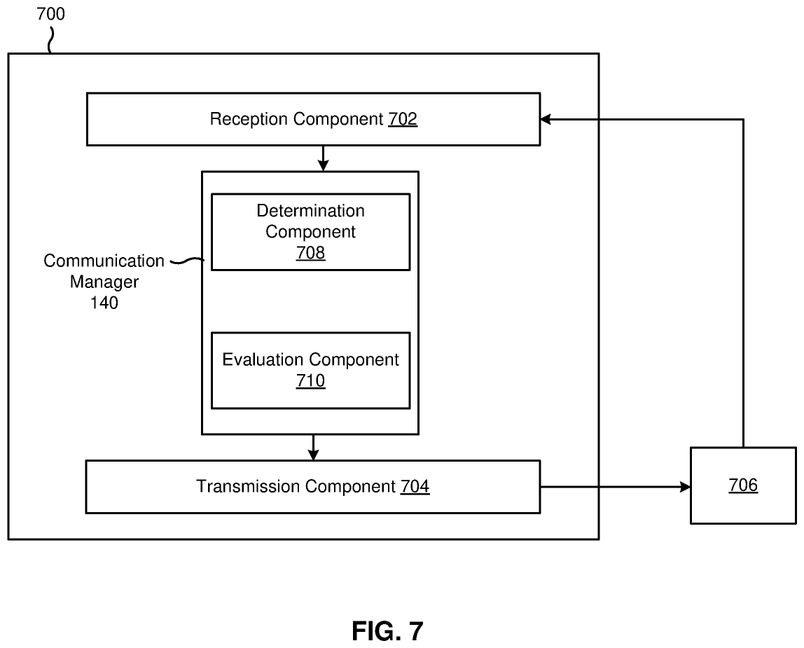

As shown in FIG. 5, in some aspects, process 500 may include determining, based at least in part on a beam failure detection reference signal configuration, a beam failure detection reference signal resource set associated with a PDCCH monitoring operation corresponding to at least two TCI states (block 510). For example, the UE (e.g., using communication manager 140 and/or determination component 708, depicted in FIG. 7) may determine, based at least in part on a beam failure detection reference signal configuration, a beam failure detection reference signal resource set associated with a PDCCH monitoring operation corresponding to at least two TCI states, as described above.

As further shown in FIG. 5, in some aspects, process 500 may include monitoring the beam failure detection reference signal resource set to identify a beam failure (block 520). For example, the UE (e.g., using communication manager 140 and/or reception component 702, depicted in FIG. 7) may monitor the beam failure detection reference signal resource set to identify a beam failure, as described above.

Process 500 may include additional aspects, such as any single aspect or any combination of aspects described below and/or in connection with one or more other processes described elsewhere herein.

In a first aspect, the beam failure detection reference signal configuration comprises an implicit configuration.

In a second aspect, alone or in combination with the first aspect, determining the beam failure detection reference signal resource set comprises determining the beam failure detection reference signal resource set based at least in part on at least one quasi co-located reference signal of at least one CORESET, wherein each CORESET of the at least one CORESET includes only a single active TCI state.

In a third aspect, alone or in combination with one or more of the first and second aspects, determining the beam failure detection reference signal resource set comprises determining the beam failure detection reference signal resource set based at least in part on at least one quasi co-located reference signal of at least one CORESET, wherein each CORESET of the at least one CORESET includes either a single active TCI state or two active TCI states.

In a fourth aspect, alone or in combination with one or more of the first through third aspects, determining the beam failure detection reference signal resource set comprises determining the beam failure detection reference signal resource set based at least in part on at least one quasi co-located reference signal of at least one CORESET, wherein each CORESET of the at least one CORESET includes two active TCI states.

In a fifth aspect, alone or in combination with one or more of the first through fourth aspects, the beam failure detection reference signal configuration comprises an explicit configuration.

In a sixth aspect, alone or in combination with the fifth aspect, process 500 includes receiving the explicit configuration, wherein the explicit configuration is carried in at least one of an RRC message or a MAC-CE.

In a seventh aspect, alone or in combination with one or more of the fifth through sixth aspects, the explicit configuration includes a pairing indication that indicates at least one of a pair of CSI-RS resources or a pair of SSB resources, and wherein determining the beam failure detection reference signal resource set comprises determining the beam failure detection reference signal resource set based at least in part on the pairing indication.

In an eighth aspect, alone or in combination with one or more of the fifth through seventh aspects, the explicit configuration includes an index set indication that indicates at least one of a set of periodic CSI-RS configuration indexes or a set of SSB configuration indexes, and wherein determining the beam failure detection reference signal resource set comprises determining the beam failure detection reference signal resource set based at least in part on the index set indication.

In a ninth aspect, alone or in combination with one or more of the first through eighth aspects, process 500 includes performing a beam failure instance evaluation associated with the beam failure detection reference signal resource set.

In a tenth aspect, alone or in combination with the ninth aspect, process 500 includes performing the PDCCH monitoring operation by monitoring a PDCCH transmission using the at least two TCI states.

In an eleventh aspect, alone or in combination with the tenth aspect, performing the beam failure instance evaluation comprises determining at least one hypothetical block error rate calculation associated with the PDCCH transmission.

In a twelfth aspect, alone or in combination with the eleventh aspect, the beam failure detection reference signal resource set comprises at least one quasi co-located reference signal of at least one CORESET, and wherein determining the at least one hypothetical block error rate calculation comprises determining two hypothetical block error rates for each reference signal of the at least one quasi co-located reference signal.

In a thirteenth aspect, alone or in combination with one or more of the eleventh through twelfth aspects, the beam failure detection reference signal resource set comprises at least one of a pair of CSI-RS resources or a pair of SSB resources, and wherein determining the at least one hypothetical block error rate calculation comprises determining two hypothetical block error rates for each pair of the at least one of the pair of CSI-RS resources or the pair of SSB resources.

In a fourteenth aspect, alone or in combination with one or more of the eleventh through thirteenth aspects, the at least two TCI states corresponds to at least one pair of beam failure detection reference signals and comprises a first TCI state associated with an SFN and a second TCI state associated with the SFN, wherein the first TCI state corresponds to a first beam failure detection reference signal of a pair of beam failure detection reference signals of the at least one pair of beam failure detection reference signals and the second TCI state corresponds to a second beam failure detection reference signal of the pair of beam failure detection reference signals, and wherein determining the at least one hypothetical block error rate calculation comprises determining one hypothetical block error rate calculation for the pair of beam failure detection reference signals.

In a fifteenth aspect, alone or in combination with the fourteenth aspect, determining the one hypothetical block error rate calculation for the pair of beam failure detection reference signals comprises determining an average block error rate.

In a sixteenth aspect, alone or in combination with the fifteenth aspect, determining the average block error rate comprises determining a weighted average of a first hypothetical block error rate corresponding to the first beam failure detection reference signal of the pair of beam failure detection reference signals and a second hypothetical block error rate corresponding to the second beam failure detection reference signal of the pair of beam failure detection reference signals.

In a seventeenth aspect, alone or in combination with the sixteenth aspect, determining the weighted average comprises determining a weighted power mean of the first hypothetical block error rate and the second hypothetical block error rate.

In an eighteenth aspect, alone or in combination with the seventeenth aspect, determining the weighted power mean comprises determining a sum of a weighted first hypothetical block error rate and a weighted second hypothetical block error rate, and determining an exponential value of the sum based as least in part on an exponent comprising a fraction in which a denominator comprises a value corresponding to a power parameter.

In a nineteenth aspect, alone or in combination with the eighteenth aspect, process 500 includes determining the weighted first hypothetical block error rate by determining a product of the first hypothetical block error rate and a first weight value, and determining the weighted second hypothetical block error rate by determining a product of the second hypothetical block error rate and a second weight value.

In a twentieth aspect, alone or in combination with the nineteenth aspect, a sum of the first weight value and the second weight value is equal to one.

In a twenty-first aspect, alone or in combination with one or more of the eighteenth through twentieth aspects, the weighted power mean comprises a minimum of the first hypothetical block error rate and the second hypothetical block error rate, a harmonic mean, a geometric mean, an arithmetic mean, or a maximum of the first hypothetical block error rate and the second hypothetical block error rate.

In a twenty-second aspect, alone or in combination with one or more of the first through twenty-first aspects, process 500 includes identifying the beam failure, and determining, during a beam failure recovery procedure, at least one new beam indication reference signal based at least in part on identifying the beam failure.

In a twenty-third aspect, alone or in combination with the twenty-second aspect, determining the at least one new beam indication reference signal comprises determining one reference signal during the beam failure recovery procedure.

In a twenty-fourth aspect, alone or in combination with one or more of the twenty-second through twenty-third aspects, determining the at least one new beam indication reference signal comprises determining a first reference signal from a first new beam indication resource set, and determining a second reference signal from a second new beam indication resource set.

In a twenty-fifth aspect, alone or in combination with one or more of the twenty-second through twenty-fourth aspects, determining the at least one new beam indication reference signal comprises determining a first reference signal from a first new beam indication resource pair, and determining a second reference signal from a second new beam indication resource pair.

In a twenty-sixth aspect, alone or in combination with one or more of the twenty-second through twenty-fifth aspects, determining the at least one new beam indication reference signal comprises determining a reference signal pair of a plurality of reference signal pairs.

In a twenty-seventh aspect, alone or in combination with one or more of the twenty-second through twenty-sixth aspects, the beam failure recovery procedure corresponds to at least one of a primary cell, a secondary cell, or a multi-TRP operation in a cell.

In a twenty-eighth aspect, alone or in combination with one or more of the first through twenty-seventh aspects, process 500 includes performing the PDCCH monitoring operation.

In a twenty-ninth aspect, alone or in combination with the twenty-eighth aspect, performing the PDCCH monitoring operation comprises monitoring a PDCCH transmission associated with one control resource set having two active TCI states.

In a thirtieth aspect, alone or in combination with the twenty-ninth aspect, the PDCCH transmission comprises a single frequency network transmission.

In a thirty-first aspect, alone or in combination with one or more of the twenty-eighth through thirtieth aspects, performing the PDCCH monitoring operation comprises monitoring a PDCCH transmission corresponding to one search space set associated with two different CORESETs, wherein each CORESET of the two different CORESETs has an active TCI state.

In a thirty-second aspect, alone or in combination with one or more of the twenty-eighth through thirty-first aspects, performing the PDCCH monitoring operation comprises monitoring a PDCCH transmission corresponding to two search space sets associated with two corresponding CORESETs, wherein each CORESET of the two corresponding CORESETs has an active TCI state.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 110) performs operations associated with beam failure detection for a PDCCH monitoring operation corresponding to at least two TCI states.

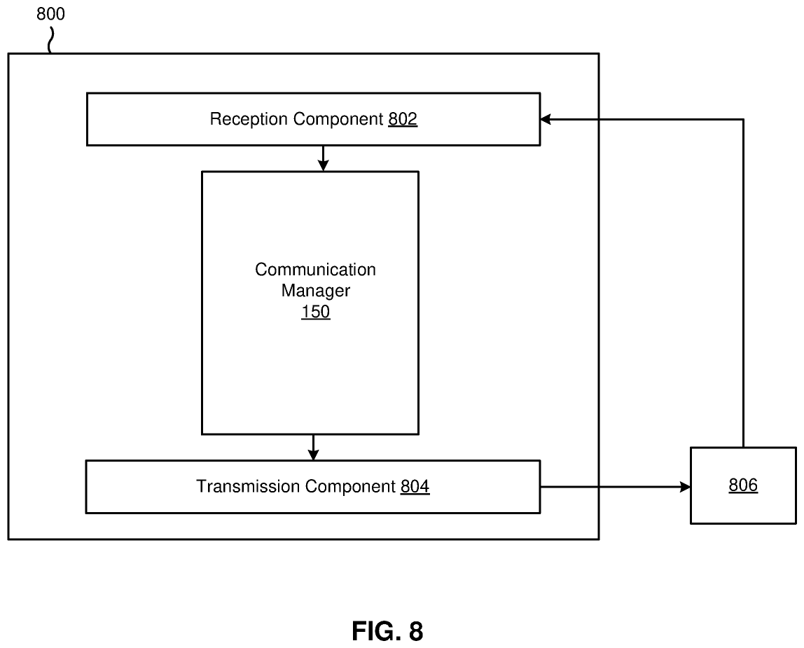

As shown in FIG. 6, in some aspects, process 600 may include transmitting a beam failure detection reference signal based at least in part on a beam failure detection reference signal configuration, wherein the beam failure detection reference signal corresponds to a beam failure detection reference signal resource set associated with a PDCCH monitoring operation corresponding to at least two TCI states (block 610). For example, the base station (e.g., using communication manager 150 and/or transmission component 804, depicted in FIG. 8) may transmit a beam failure detection reference signal based at least in part on a beam failure detection reference signal configuration, wherein the beam failure detection reference signal corresponds to a beam failure detection reference signal resource set associated with a PDCCH monitoring operation corresponding to at least two TCI states, as described above.

As further shown in FIG. 6, in some aspects, process 600 may include receiving an indicator that indicates at least one new beam indication reference signal based at least in part on an identification of a beam failure (block 620). For example, the base station (e.g., using communication manager 150 and/or reception component 802, depicted in FIG. 8) may receive an indicator that indicates at least one new beam indication reference signal based at least in part on an identification of a beam failure, as described above.

Process 600 may include additional aspects, such as any single aspect or any combination of aspects described below and/or in connection with one or more other processes described elsewhere herein.

In a first aspect, the beam failure detection reference signal configuration comprises an implicit configuration.

In a second aspect, alone or in combination with the first aspect, the beam failure detection reference signal resource set is based at least in part on at least one quasi co-located reference signal of at least one CORESET, wherein each CORESET of the at least one CORESET includes only a single active TCI state.

In a third aspect, alone or in combination with one or more of the first and second aspects, the beam failure detection reference signal resource set is based at least in part on at least one quasi co-located reference signal of at least one CORESET, wherein each CORESET of the at least one CORESET includes either a single active TCI state or two active TCI states.

In a fourth aspect, alone or in combination with one or more of the first through third aspects, the beam failure detection reference signal resource set is based at least in part on at least one quasi co-located reference signal of at least one CORESET, wherein each CORESET of the at least one CORESET includes two active TCI states.

In a fifth aspect, alone or in combination with one or more of the first through fourth aspects, the beam failure detection reference signal configuration comprises an explicit configuration.

In a sixth aspect, alone or in combination with the fifth aspect, process 600 includes transmitting the explicit configuration, wherein the explicit configuration is carried in at least one of an RRC message or a MAC-CE.

In a seventh aspect, alone or in combination with one or more of the fifth through sixth aspects, the explicit configuration includes a pairing indication that indicates at least one of a pair of CSI-RS resources or a pair of SSB resources, and wherein the beam failure detection reference signal resource set is based at least in part on the pairing indication.

In an eighth aspect, alone or in combination with one or more of the fifth through seventh aspects, the explicit configuration includes an index set indication that indicates at least one of a set of periodic CSI-RS configuration indexes or a set of SSB configuration indexes, and wherein the beam failure detection reference signal resource set is based at least in part on the index set indication.

In a ninth aspect, alone or in combination with one or more of the fifth through eighth aspects, a beam failure instance evaluation is associated with the beam failure detection reference signal resource set.

In a tenth aspect, alone or in combination with the ninth aspect, the PDCCH monitoring operation corresponds to a PDCCH transmission.

In an eleventh aspect, alone or in combination with the tenth aspect, the beam failure instance evaluation comprises at least one hypothetical block error rate calculation associated with the PDCCH transmission.

In a twelfth aspect, alone or in combination with the eleventh aspect, the beam failure detection reference signal resource set comprises at least one quasi co-located reference signal of at least one CORESET, and wherein the at least one hypothetical block error rate calculation comprises a determination of two hypothetical block error rates for each reference signal of the at least one quasi co-located reference signal.

In a thirteenth aspect, alone or in combination with one or more of the eleventh through twelfth aspects, the beam failure detection reference signal resource set comprises at least one of a pair of CSI-RS resources or a pair of SSB resources, and wherein the at least one hypothetical block error rate calculation comprises determination of two hypothetical block error rates for each pair of the at least one of the pair of CSI-RS resources or the pair of SSB resources.

In a fourteenth aspect, alone or in combination with one or more of the eleventh through thirteenth aspects, the at least two TCI states corresponds to at least one pair of beam failure detection reference signals and comprises a first TCI state associated with an SFN and a second TCI state associated with the SFN, wherein the first TCI state corresponds to a first beam failure detection reference signal of a pair of beam failure detection reference signals of the at least one pair of beam failure detection reference signals and the second TCI state corresponds to a second beam failure detection reference signal of the pair of beam failure detection reference signals, and wherein the at least one hypothetical block error rate calculation comprises determination of one hypothetical block error rate calculation for the pair of beam failure detection reference signals.

In a fifteenth aspect, alone or in combination with the fourteenth aspect, the determination of the one hypothetical block error rate calculation for the pair of beam failure detection reference signals comprises a determination of an average block error rate.

In a sixteenth aspect, alone or in combination with the fifteenth aspect, determination of the average block error rate comprises determination of a weighted average of a first hypothetical block error rate corresponding to the first beam failure detection reference signal of the pair of beam failure detection reference signals and a second hypothetical block error rate corresponding to the second beam failure detection reference signal of the pair of beam failure detection reference signals.

In a seventeenth aspect, alone or in combination with the sixteenth aspect, determination of the weighted average comprises determination of a weighted power mean of the first hypothetical block error rate and the second hypothetical block error rate.

In an eighteenth aspect, alone or in combination with the seventeenth aspect, determination of the weighted power mean comprises determination of a sum of a weighted first hypothetical block error rate and a weighted second hypothetical block error rate, and determination of an exponential value of the sum based as least in part on an exponent comprising a fraction in which a denominator comprises a value corresponding to a power parameter.

In a nineteenth aspect, alone or in combination with the eighteenth aspect, process 600 includes determination of the weighted first hypothetical block error rate by determination of a product of the first hypothetical block error rate and a first weight value, and determination of the weighted second hypothetical block error rate by determination of a product of the second hypothetical block error rate and a second weight value.

In a twentieth aspect, alone or in combination with the nineteenth aspect, a sum of the first weight value and the second weight value is equal to one.

In a twenty-first aspect, alone or in combination with one or more of the eighteenth through twentieth aspects, the weighted power mean comprises a minimum of the first hypothetical block error rate and the second hypothetical block error rate, a harmonic mean, a geometric mean, an arithmetic mean, or a maximum of the first hypothetical block error rate and the second hypothetical block error rate.

In a twenty-second aspect, alone or in combination with one or more of the first through twenty-first aspects, determination of at least one new beam indication reference signal comprises determination of one reference signal during the beam failure recovery procedure.

In a twenty-third aspect, alone or in combination with the twenty-second aspect, determination of the at least one new beam indication reference signal comprises determination of a first reference signal from a first new beam indication resource set, and determination of a second reference signal from a second new beam indication resource set.

In a twenty-fourth aspect, alone or in combination with one or more of the twenty-second through twenty-third aspects, determination of the at least one new beam indication reference signal comprises determination of a first reference signal from a first new beam indication resource pair, and determination of a second reference signal from a second new beam indication resource pair.

In a twenty-fifth aspect, alone or in combination with one or more of the twenty-second through twenty-fourth aspects, determination of the at least one new beam indication reference signal comprises determination of a reference signal pair of a plurality of reference signal pairs.

In a twenty-sixth aspect, alone or in combination with one or more of the twenty-second through twenty-fifth aspects, the beam failure recovery procedure corresponds to at least one of a primary cell, a secondary cell, or a multiple transmit receive point operation in a cell.

In a twenty-seventh aspect, alone or in combination with one or more of the first through twenty-sixth aspects, performance of the PDCCH monitoring operation comprises monitoring a PDCCH transmission associated with one control resource set having two active TCI states.

In a twenty-eighth aspect, alone or in combination with the twenty-seventh aspect, the PDCCH transmission comprises a single frequency network transmission.

In a twenty-ninth aspect, alone or in combination with the twenty-eighth aspect, performance of the PDCCH monitoring operation comprises monitoring a PDCCH transmission corresponding to one search space set associated with two different CORESETs, wherein each CORESET of the two different CORESETs has an active TCI state.

In a thirtieth aspect, alone or in combination with one or more of the twenty-eighth through twenty-ninth aspects, performance of the PDCCH monitoring operation comprises monitoring a PDCCH transmission corresponding to two search space sets associated with two corresponding CORESETs, wherein each CORESET of the two corresponding CORESETs has an active TCI state.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a block diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include one or more of a determination component 708 or an evaluation component 710, among other examples.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described above in connection with FIG. 2. Additionally, or alternatively, one or more components shown in FIG. 7 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the UE described above in connection with FIG. 2. In some aspects, the transmission component 704 may be co-located with the reception component 702 in a transceiver.

The determination component 708 may determine, based at least in part on a beam failure detection reference signal configuration, a beam failure detection reference signal resource set associated with a PDCCH monitoring operation corresponding to at least two TCI states. The reception component 702 may monitor the beam failure detection reference signal resource set to identify a beam failure.

The reception component 702 may receive the explicit configuration, wherein the explicit configuration is carried in at least one of an RRC message or a MAC-CE.

The evaluation component 710 may perform a beam failure instance evaluation associated with the beam failure detection reference signal resource set. The reception component 702 may perform the PDCCH monitoring operation by monitoring a PDCCH transmission using the at least two TCI states. The determination component 710 may determine the weighted first hypothetical block error rate by determining a product of the first hypothetical block error rate and a first weight value.

The determination component 708 may determine the weighted second hypothetical block error rate by determining a product of the second hypothetical block error rate and a second weight value.

The evaluation component 710 may identify the beam failure. The determination component 708 may determine, during a beam failure recovery procedure, at least one new beam indication reference signal based at least in part on identifying the beam failure.

In some aspects, the communication manager 140 may include one or more antennas, a modulator, a transmit MIMO processor, a transmit processor, a controller/processor, a memory, or a combination thereof, of the base station described above in connection with FIG. 2. In some aspects, the communication manager 140 may include the reception component 702 and/or the transmission component 704.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a block diagram of an example apparatus 800 for wireless communication. The apparatus 800 may be a base station, or a base station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station described above in connection with FIG. 2. Additionally, or alternatively, one or more components shown in FIG. 8 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a demodulator, a MIMO detector, a receive processor, a controller/processor, a memory, or a combination thereof, of the base station described above in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the base station described above in connection with FIG. 2. In some aspects, the transmission component 804 may be co-located with the reception component 802 in a transceiver.

The transmission component 804 may transmit a beam failure detection reference signal based at least in part on a beam failure detection reference signal configuration, wherein the beam failure detection reference signal corresponds to a beam failure detection reference signal resource set associated with a PDCCH monitoring operation corresponding to at least two TCI states. The reception component 802 may receive an indicator that indicates at least one new beam indication reference signal based at least in part on an identification of a beam failure. The transmission component 804 may transmit the explicit configuration, wherein the explicit configuration is carried in at least one of an RRC message or a MAC-CE.

The communication manager 150 may determine resource allocations, generate reference signal sequences, and/or perform beam management, among other examples. In some aspects, the communication manager 150 may include one or more antennas, a modulator, a transmit MIMO processor, a transmit processor, a controller/processor, a memory, or a combination thereof, of the base station described above in connection with FIG. 2. In some aspects, the communication manager 150 may include the reception component 802 and/or the transmission component 804.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: determining, based at least in part on a beam failure detection reference signal configuration, a beam failure detection reference signal resource set associated with a physical downlink control channel (PDCCH) monitoring operation corresponding to at least two transmission configuration indicator (TCI) states; and monitoring the beam failure detection reference signal resource set to identify a beam failure.

Aspect 2: The method of Aspect 1, wherein the beam failure detection reference signal configuration comprises an implicit configuration.

Aspect 3: The method of any of Aspects 1-2, wherein determining the beam failure detection reference signal resource set comprises determining the beam failure detection reference signal resource set based at least in part on at least one quasi co-located reference signal of at least one control resource set (CORESET), wherein each CORESET of the at least one CORESET includes only a single active TCI state.

Aspect 4: The method of any of Aspects 1-3, wherein determining the beam failure detection reference signal resource set comprises determining the beam failure detection reference signal resource set based at least in part on at least one quasi co-located reference signal of at least one control resource set (CORESET), wherein each CORESET of the at least one CORESET includes either a single active TCI state or two active TCI states.

Aspect 5: The method of any of Aspects 1-4, wherein determining the beam failure detection reference signal resource set comprises determining the beam failure detection reference signal resource set based at least in part on at least one quasi co-located reference signal of at least one control resource set (CORESET), wherein each CORESET of the at least one CORESET includes two active TCI states.

Aspect 6: The method of any of Aspects 1-5, wherein the beam failure detection reference signal configuration comprises an explicit configuration.

Aspect 7: The method of Aspect 6, further comprising receiving the explicit configuration, wherein the explicit configuration is carried in at least one of a radio resource control message or a medium access control control element.

Aspect 8: The method of any of Aspects 6-7, wherein the explicit configuration includes a pairing indication that indicates at least one of a pair of channel state information reference signal resources or a pair of synchronization signal block resources, and wherein determining the beam failure detection reference signal resource set comprises determining the beam failure detection reference signal resource set based at least in part on the pairing indication.

Aspect 9: The method of any of Aspects 6-8, wherein the explicit configuration includes an index set indication that indicates at least one of a set of periodic channel state information reference signal configuration indexes or a set of synchronization signal block configuration indexes, and wherein determining the beam failure detection reference signal resource set comprises determining the beam failure detection reference signal resource set based at least in part on the index set indication.

Aspect 10: The method of any of Aspects 1-9, further comprising performing the PDCCH monitoring operation by monitoring a PDCCH transmission using the at least two TCI states.

Aspect 11: The method of any of Aspects 1-10, further comprising performing a beam failure instance evaluation associated with the beam failure detection reference signal resource set.

Aspect 12: The method of Aspect 11, wherein performing the beam failure instance evaluation comprises determining at least one hypothetical block error rate calculation associated with the PDCCH transmission.

Aspect 13: The method of Aspect 12, wherein the beam failure detection reference signal resource set comprises at least one quasi co-located reference signal of at least one control resource set (CORESET), and wherein determining the at least one hypothetical block error rate calculation comprises determining two hypothetical block error rates for each reference signal of the at least one quasi co-located reference signal.

Aspect 14: The method of any of Aspects 12-13, wherein the beam failure detection reference signal resource set comprises at least one of a pair of channel state information reference signal (CSI-RS) resources or a pair of synchronization signal block (SSB) resources, and wherein determining the at least one hypothetical block error rate calculation comprises determining two hypothetical block error rates for each pair of the at least one of the pair of CSI-RS resources or the pair of SSB resources.

Aspect 15: The method of any of Aspects 12-14, wherein the at least two TCI states corresponds to at least one pair of beam failure detection reference signals and comprises a first TCI state associated with a single frequency network (SFN) and a second TCI state associated with the SFN, wherein the first TCI state corresponds to a first beam failure detection reference signal of a pair of beam failure detection reference signals of the at least one pair of beam failure detection reference signals and the second TCI state corresponds to a second beam failure detection reference signal of the pair of beam failure detection reference signals, and wherein determining the at least one hypothetical block error rate calculation comprises determining one hypothetical block error rate calculation for the pair of beam failure detection reference signals.

Aspect 16: The method of Aspect 15, wherein determining the one hypothetical block error rate calculation for the pair of beam failure detection reference signals comprises determining an average block error rate.

Aspect 17: The method of Aspect 16, wherein determining the average block error rate comprises determining a weighted average of a first hypothetical block error rate corresponding to the first beam failure detection reference signal of the pair of beam failure detection reference signals and a second hypothetical block error rate corresponding to the second beam failure detection reference signal of the pair of beam failure detection reference signals.

Aspect 18: The method of Aspect 17, wherein determining the weighted average comprises determining a weighted power mean of the first hypothetical block error rate and the second hypothetical block error rate.

Aspect 19: The method of Aspect 18, wherein determining the weighted power mean comprises: determining a sum of a weighted first hypothetical block error rate and a weighted second hypothetical block error rate; and determining an exponential value of the sum based as least in part on an exponent comprising a fraction in which a denominator comprises a value corresponding to a power parameter.

Aspect 20: The method of Aspect 19, further comprising: determining the weighted first hypothetical block error rate by determining a product of the first hypothetical block error rate and a first weight value; and determining the weighted second hypothetical block error rate by determining a product of the second hypothetical block error rate and a second weight value.

Aspect 21: The method of Aspect 20, wherein a sum of the first weight value and the second weight value is equal to one.

Aspect 22: The method of any of Aspects 19-21, wherein the weighted power mean comprises: a minimum of the first hypothetical block error rate and the second hypothetical block error rate, a harmonic mean, a geometric mean, an arithmetic mean, or a maximum of the first hypothetical block error rate and the second hypothetical block error rate.

Aspect 23: The method of any of Aspects 1-22, further comprising: identifying the beam failure; and determining, during a beam failure recovery procedure, at least one new beam indication reference signal based at least in part on identifying the beam failure.

Aspect 24: The method of Aspect 23, wherein determining the at least one new beam indication reference signal comprises determining one reference signal during the beam failure recovery procedure.

Aspect 25: The method of any of Aspects 23-24, wherein determining the at least one new beam indication reference signal comprises: determining a first reference signal from a first new beam indication resource set; and determining a second reference signal from a second new beam indication resource set.

Aspect 26: The method of any of Aspects 23-25, wherein determining the at least one new beam indication reference signal comprises: determining a first reference signal from a first new beam indication resource pair; and determining a second reference signal from a second new beam indication resource pair.

Aspect 27: The method of any of Aspects 23-26, wherein determining the at least one new beam indication reference signal comprises determining a reference signal pair of a plurality of reference signal pairs.

Aspect 28: The method of any of Aspects 23-27, wherein the beam failure recovery procedure corresponds to at least one of: a primary cell, a secondary cell, or a multiple transmit receive point operation in a cell.

Aspect 29: The method of any of Aspects 1-28, further comprising performing the PDCCH monitoring operation.

Aspect 30: The method of Aspect 29, wherein performing the PDCCH monitoring operation comprises monitoring a PDCCH transmission associated with one control resource set having two active TCI states.

Aspect 31: The method of Aspect 30, wherein the PDCCH transmission comprises a single frequency network transmission.

Aspect 32: The method of any of Aspects 29-31, wherein performing the PDCCH monitoring operation comprises monitoring a PDCCH transmission corresponding to one search space set associated with two different control resource sets (CORESETs), wherein each CORESET of the two different CORESETs has an active TCI state.

Aspect 33: The method of any of Aspects 29-31, wherein performing the PDCCH monitoring operation comprises monitoring a PDCCH transmission corresponding to two search space sets associated with two corresponding control resource sets (CORESETs), wherein each CORESET of the two corresponding CORESETs has an active TCI state.

Aspect 34: A method of wireless communication performed by a base station, comprising: transmitting a beam failure detection reference signal based at least in part on a beam failure detection reference signal configuration, wherein the beam failure detection reference signal corresponds to a beam failure detection reference signal resource set associated with a physical downlink control channel (PDCCH) monitoring operation corresponding to at least two transmission configuration indicator (TCI) states; and receiving an indicator that indicates at least one new beam indication reference signal based at least in part on an identification of a beam failure.

Aspect 35: The method of Aspect 34, wherein the beam failure detection reference signal configuration comprises an implicit configuration.

Aspect 36: The method of any of Aspects 34-35, wherein the beam failure detection reference signal resource set is based at least in part on at least one quasi co-located reference signal of at least one control resource set (CORESET), wherein each CORESET of the at least one CORESET includes only a single active TCI state.

Aspect 37: The method of any of Aspects 34-36, wherein the beam failure detection reference signal resource set is based at least in part on at least one quasi co-located reference signal of at least one control resource set (CORESET), wherein each CORESET of the at least one CORESET includes either a single active TCI state or two active TCI states.

Aspect 38: The method of any of Aspects 34-37, wherein the beam failure detection reference signal resource set is based at least in part on at least one quasi co-located reference signal of at least one control resource set (CORESET), wherein each CORESET of the at least one CORESET includes two active TCI states.

Aspect 39: The method of any of Aspects 34-38, wherein the beam failure detection reference signal configuration comprises an explicit configuration.

Aspect 40: The method of Aspect 39, further comprising transmitting the explicit configuration, wherein the explicit configuration is carried in at least one of a radio resource control message or a medium access control control element.

Aspect 41: The method of any of Aspects 39-40, wherein the explicit configuration includes a pairing indication that indicates at least one of a pair of channel state information reference signal resources or a pair of synchronization signal block resources, and wherein the beam failure detection reference signal resource set is based at least in part on the pairing indication.

Aspect 42: The method of any of Aspects 39-41, wherein the explicit configuration includes an index set indication that indicates at least one of a set of periodic channel state information reference signal configuration indexes or a set of synchronization signal block configuration indexes, and wherein the beam failure detection reference signal resource set is based at least in part on the index set indication.

Aspect 43: The method of any of Aspects 39-42, wherein a beam failure instance evaluation is associated with the beam failure detection reference signal resource set.

Aspect 44: The method of Aspect 43, wherein the PDCCH monitoring operation corresponds to a PDCCH transmission.

Aspect 45: The method of Aspect 44, wherein the beam failure instance evaluation comprises at least one hypothetical block error rate calculation associated with the PDCCH transmission.

Aspect 46: The method of Aspect 45, wherein the beam failure detection reference signal resource set comprises at least one quasi co-located reference signal of at least one control resource set (CORESET), and wherein the at least one hypothetical block error rate calculation comprises a determination of two hypothetical block error rates for each reference signal of the at least one quasi co-located reference signal.

Aspect 47: The method of any of Aspects 45-46, wherein the beam failure detection reference signal resource set comprises at least one of a pair of channel state information reference signal (CSI-RS) resources or a pair of synchronization signal block (SSB) resources, and wherein the at least one hypothetical block error rate calculation comprises determination of two hypothetical block error rates for each pair of the at least one of the pair of CSI-RS resources or the pair of SSB resources.

Aspect 48: The method of any of Aspects 45-47, wherein the at least two TCI states corresponds to at least one pair of beam failure detection reference signals and comprises a first TCI state associated with a single frequency network (SFN) and a second TCI state associated with the SFN, wherein the first TCI state corresponds to a first beam failure detection reference signal of a pair of beam failure detection reference signals of the at least one pair of beam failure detection reference signals and the second TCI state corresponds to a second beam failure detection reference signal of the pair of beam failure detection reference signals, and wherein the at least one hypothetical block error rate calculation comprises determination of one hypothetical block error rate calculation for the pair of beam failure detection reference signals.

Aspect 49: The method of Aspect 48, wherein the determination of the one hypothetical block error rate calculation for the pair of beam failure detection reference signals comprises a determination of an average block error rate.

Aspect 50: The method of Aspect 49, wherein determination of the average block error rate comprises determination of a weighted average of a first hypothetical block error rate corresponding to the first beam failure detection reference signal of the pair of beam failure detection reference signals and a second hypothetical block error rate corresponding to the second beam failure detection reference signal of the pair of beam failure detection reference signals.

Aspect 51: The method of Aspect 50, wherein determination of the weighted average comprises determination of a weighted power mean of the first hypothetical block error rate and the second hypothetical block error rate.

Aspect 52: The method of Aspect 51, wherein determination of the weighted power mean comprises: determination of a sum of a weighted first hypothetical block error rate and a weighted second hypothetical block error rate; and determination of an exponential value of the sum based as least in part on an exponent comprising a fraction in which a denominator comprises a value corresponding to a power parameter.

Aspect 53: The method of Aspect 52, further comprising: determination of the weighted first hypothetical block error rate by determination of a product of the first hypothetical block error rate and a first weight value; and determination of the weighted second hypothetical block error rate by determination of a product of the second hypothetical block error rate and a second weight value.

Aspect 54: The method of Aspect 53, wherein a sum of the first weight value and the second weight value is equal to one.

Aspect 55: The method of any of Aspects 52-54, wherein the weighted power mean comprises: a minimum of the first hypothetical block error rate and the second hypothetical block error rate, a harmonic mean, a geometric mean, an arithmetic mean, or a maximum of the first hypothetical block error rate and the second hypothetical block error rate.

Aspect 56: The method of any of Aspects 39-41, wherein determination of at least one new beam indication reference signal comprises determination of one reference signal during the beam failure recovery procedure.

Aspect 57: The method of Aspect 56, wherein determination of the at least one new beam indication reference signal comprises: determination of a first reference signal from a first new beam indication resource set; and determination of a second reference signal from a second new beam indication resource set.

Aspect 58: The method of any of Aspects 56-57, wherein determination of the at least one new beam indication reference signal comprises: determination of a first reference signal from a first new beam indication resource pair; and determination of a second reference signal from a second new beam indication resource pair.

Aspect 59: The method of any of Aspects 56-58, wherein determination of the at least one new beam indication reference signal comprises determination of a reference signal pair of a plurality of reference signal pairs.

Aspect 60: The method of any of Aspects 56-59, wherein the beam failure recovery procedure corresponds to at least one of: a primary cell, a secondary cell, or a multiple transmit receive point operation in a cell.

Aspect 61: The method of any of Aspects 34-60, wherein performance of the PDCCH monitoring operation comprises monitoring a PDCCH transmission associated with one control resource set having two active TCI states.

Aspect 62: The method of Aspect 61, wherein the PDCCH transmission comprises a single frequency network transmission.

Aspect 63: The method of Aspect 62, wherein performance of the PDCCH monitoring operation comprises monitoring a PDCCH transmission corresponding to one search space set associated with two different control resource sets (CORESETs), wherein each CORESET of the two different CORESETs has an active TCI state.

Aspect 64: The method of any of Aspects 62-63, wherein performance of the PDCCH monitoring operation comprises monitoring a PDCCH transmission corresponding to two search space sets associated with two corresponding control resource sets (CORESETs), wherein each CORESET of the two corresponding CORESETs has an active TCI state.

Aspect 65: An apparatus for wireless communication at a device, comprising a processor; memory coupled with the processor; and instructions stored in the memory and executable by the processor to cause the apparatus to perform the method of one or more of Aspects 1-33.

Aspect 66: A device for wireless communication, comprising a memory and one or more processors coupled to the memory, the one or more processors configured to perform the method of one or more of Aspects 1-33.

Aspect 67: An apparatus for wireless communication, comprising at least one means for performing the method of one or more of Aspects 1-33.

Aspect 68: A non-transitory computer-readable medium storing code for wireless communication, the code comprising instructions executable by a processor to perform the method of one or more of Aspects 1-33.

Aspect 69: A non-transitory computer-readable medium storing a set of instructions for wireless communication, the set of instructions comprising one or more instructions that, when executed by one or more processors of a device, cause the device to perform the method of one or more of Aspects 1-33.

Aspect 70: An apparatus for wireless communication at a device, comprising a processor; memory coupled with the processor; and instructions stored in the memory and executable by the processor to cause the apparatus to perform the method of one or more of 34-64.

Aspect 71: A device for wireless communication, comprising a memory and one or more processors coupled to the memory, the one or more processors configured to perform the method of one or more of Aspects 34-64.

Aspect 72: An apparatus for wireless communication, comprising at least one means for performing the method of one or more of Aspects 34-64.

Aspect 73: A non-transitory computer-readable medium storing code for wireless communication, the code comprising instructions executable by a processor to perform the method of one or more of Aspects 34-64.

Aspect 74: A non-transitory computer-readable medium storing a set of instructions for wireless communication, the set of instructions comprising one or more instructions that, when executed by one or more processors of a device, cause the device to perform the method of one or more of Aspects 34-64.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors, coupled to the one or more memories, configured to:
determine, based at least in part on a beam failure detection reference signal configuration, a beam failure detection reference signal resource set associated with a physical downlink control channel (PDCCH) monitoring operation corresponding to at least two transmission configuration indicator (TCI) states; and
monitor the beam failure detection reference signal resource set to identify a beam failure.

2. The UE of claim 1, wherein the one or more processors, to determine the beam failure detection reference signal resource set, are configured to determine the beam failure detection reference signal resource set based at least in part on at least one quasi co-located reference signal of at least one control resource set (CORESET), wherein each CORESET of the at least one CORESET includes only a single active TCI state.

3. The UE of claim 1, wherein the one or more processors, to determine the beam failure detection reference signal resource set, are configured to determine the beam failure detection reference signal resource set based at least in part on at least one quasi co-located reference signal of at least one control resource set (CORESET), wherein each CORESET of the at least one CORESET includes two active TCI states.

4. The UE of claim 1, wherein the beam failure detection reference signal configuration comprises an explicit configuration, wherein the one or more processors are further configured to receive the explicit configuration, and wherein the explicit configuration is carried in at least one of a radio resource control message or a medium access control control element.

5. The UE of claim 1, wherein the beam failure detection reference signal configuration comprises an explicit configuration, wherein the explicit configuration includes a pairing indication that indicates at least one of a pair of channel state information reference signal resources or a pair of synchronization signal block resources, and
wherein the one or more processors, to determine the beam failure detection reference signal resource set, are configured to determine the beam failure detection reference signal resource set based at least in part on the pairing indication.

6. The UE of claim 1, wherein the beam failure detection reference signal configuration comprises an explicit configuration, wherein the explicit configuration includes an index set indication that indicates at least one of a set of periodic channel state information reference signal configuration indexes or a set of synchronization signal block configuration indexes, and
wherein the one or more processors, to determine the beam failure detection reference signal resource set, are configured to determine the beam failure detection reference signal resource set based at least in part on the index set indication.

7. The UE of claim 1, wherein the one or more processors are further configured to perform the PDCCH monitoring operation by monitoring a PDCCH transmission using the at least two TCI states.

8. The UE of claim 1, wherein the one or more processors are further configured to perform a beam failure instance evaluation associated with the beam failure detection reference signal resource set.

9. The UE of claim 8, wherein the one or more processors, to perform the beam failure instance evaluation, are configured to determine at least one hypothetical block error rate calculation associated with the PDCCH transmission.

10. The UE of claim 9, wherein the beam failure detection reference signal resource set comprises at least one quasi co-located reference signal of at least one control resource set (CORESET), and
wherein the one or more processors, to determine the at least one hypothetical block error rate calculation, are configured to determine two hypothetical block error rates for each reference signal of the at least one quasi co-located reference signal.

11. The UE of claim 9, wherein the beam failure detection reference signal resource set comprises at least one of a pair of channel state information reference signal (CSI-RS) resources or a pair of synchronization signal block (SSB) resources, and
wherein the one or more processors, to determine the at least one hypothetical block error rate calculation, are configured to determine two hypothetical block error rates for each pair of the at least one of the pair of CSI-RS resources or the pair of SSB resources.

12. The UE of claim 9, wherein the at least two TCI states corresponds to at least one pair of beam failure detection reference signals and comprises a first TCI state associated with a single frequency network (SFN) and a second TCI state associated with the SFN, wherein the first TCI state corresponds to a first beam failure detection reference signal of a pair of beam failure detection reference signals of the at least one pair of beam failure detection reference signals and the second TCI state corresponds to a second beam failure detection reference signal of the pair of beam failure detection reference signals, and
wherein the one or more processors, to determine the at least one hypothetical block error rate calculation, are configured to determine one hypothetical block error rate calculation for the pair of beam failure detection reference signals.

13. The UE of claim 12, wherein the one or more processors, to determine the one hypothetical block error rate calculation for the pair of beam failure detection reference signals, are configured to determine an average block error rate.

14. The UE of claim 13, wherein the one or more processors, to determine the average block error rate, are configured to determine a weighted average of a first hypothetical block error rate corresponding to the first beam failure detection reference signal of the pair of beam failure detection reference signals and a second hypothetical block error rate corresponding to the second beam failure detection reference signal of the pair of beam failure detection reference signals.

15. The UE of claim 14, wherein the one or more processors, to determine the weighted average, are configured to determine a weighted power mean of the first hypothetical block error rate and the second hypothetical block error rate.

16. The UE of claim 15, wherein the one or more processors, to determine the weighted power mean, are configured to:
determine a sum of a weighted first hypothetical block error rate and a weighted second hypothetical block error rate; and
determine an exponential value of the sum based as least in part on an exponent comprising a fraction in which a denominator comprises a value corresponding to a power parameter.

17. The UE of claim 16 wherein the one or more processors are further configured to:
determine the weighted first hypothetical block error rate by determining a product of the first hypothetical block error rate and a first weight value; and
determine the weighted second hypothetical block error rate by determining a product of the second hypothetical block error rate and a second weight value.

18. The UE of claim 17, wherein a sum of the first weight value and the second weight value is equal to one.

19. The UE of claim 15, wherein the weighted power mean comprises:
a minimum of the first hypothetical block error rate and the second hypothetical block error rate,
a harmonic mean,
a geometric mean,
an arithmetic mean, or
a maximum of the first hypothetical block error rate and the second hypothetical block error rate.

20. The UE of claim 1, wherein the one or more processors are further configured to:
identify the beam failure; and
determine, during a beam failure recovery procedure, at least one new beam indication reference signal based at least in part on identifying the beam failure.

21. The UE of claim 20, wherein the one or more processors, to determine the at least one new beam indication reference signal, are configured to:
determine a first reference signal from a first new beam indication resource set; and
determine a second reference signal from a second new beam indication resource set.

22. The UE of claim 20, wherein the one or more processors, to determine the at least one new beam indication reference signal, are configured to determine a reference signal pair of a plurality of reference signal pairs.

23. The UE of claim 1, wherein the one or more processors are further configured to perform the PDCCH monitoring operation, and wherein the one or more processors, to perform the PDCCH monitoring operation, are configured to monitor a PDCCH transmission associated with one control resource set having two active TCI states.

24. The UE of claim 23, wherein the PDCCH transmission comprises a single frequency network transmission.

25. The UE of claim 1, wherein the one or more processors are further configured to perform the PDCCH monitoring operation, wherein performing the PDCCH monitoring operation comprises monitoring a PDCCH transmission corresponding to one search space set associated with two different control resource sets (CORESETs), wherein each CORESET of the two different CORESETs has an active TCI state.

26. The UE of claim 1, wherein the one or more processors are further configured to perform the PDCCH monitoring operation, wherein performing the PDCCH monitoring operation comprises monitoring a PDCCH transmission corresponding to two search space sets associated with two corresponding control resource sets (CORESETs), wherein each CORESET of the two corresponding CORESETs has an active TCI state.

27. A base station for wireless communication, comprising:
one or more memories; and
one or more processors, coupled to the one or more memories, configured to:
transmit a beam failure detection reference signal based at least in part on a beam failure detection reference signal configuration, wherein the beam failure detection reference signal corresponds to a beam failure detection reference signal resource set associated with a physical downlink control channel (PDCCH) monitoring operation corresponding to at least two transmission configuration indicator (TCI) states; and
receive an indicator that indicates at least one new beam indication reference signal based at least in part on an identification of a beam failure.

28. The base station of claim 27, wherein the beam failure detection reference signal resource set is based at least in part on at least one quasi co-located reference signal of at least one control resource set (CORESET), wherein each CORESET of the at least one CORESET includes only a single active TCI state.

29. The base station of claim 27, wherein the beam failure detection reference signal resource set is based at least in part on at least one quasi co-located reference signal of at least one control resource set (CORESET), wherein each CORESET of the at least one CORESET includes two active TCI states.

30. The base station of claim 27, wherein the beam failure detection reference signal configuration comprises an explicit configuration, wherein the one or more processors are further configured to transmit the explicit configuration, and wherein the explicit configuration is carried in at least one of a radio resource control message or a medium access control control element.

31-32. (canceled)

33. The base station of claim 27, wherein the beam failure detection reference signal configuration comprises an explicit configuration, and wherein a beam failure instance evaluation is associated with the beam failure detection reference signal resource set.

34. The base station of claim 27, wherein the PDCCH monitoring operation corresponds to a PDCCH transmission, and wherein the beam failure instance evaluation comprises at least one hypothetical block error rate calculation associated with the PDCCH transmission.

35-42. (canceled)

43. A method of wireless communication performed by a user equipment (UE), comprising:
determining, based at least in part on a beam failure detection reference signal configuration, a beam failure detection reference signal resource set associated with a physical downlink control channel (PDCCH) monitoring operation corresponding to at least two transmission configuration indicator (TCI) states; and
monitoring the beam failure detection reference signal resource set to identify a beam failure.

44. A method of wireless communication performed by a base station, comprising:
transmitting a beam failure detection reference signal based at least in part on a beam failure detection reference signal configuration, wherein the beam failure detection reference signal corresponds to a beam failure detection reference signal resource set associated with a physical downlink control channel (PDCCH) monitoring operation corresponding to at least two transmission configuration indicator (TCI) states; and
receiving an indicator that indicates at least one new beam indication reference signal based at least in part on an identification of a beam failure.

45. A non-transitory computer-readable medium storing a set of instructions for wireless communication, the set of instructions comprising:
one or more instructions that, when executed by one or more processors of a user equipment (UE), cause the UE to:
determine, based at least in part on a beam failure detection reference signal configuration, a beam failure detection reference signal resource set associated with a physical downlink control channel (PDCCH) monitoring operation corresponding to at least two transmission configuration indicator (TCI) states; and
monitor the beam failure detection reference signal resource set to identify a beam failure.

46-48. (canceled)
